(19) United States
(12) Patent Application Publication
(10) Pub. No.: US 2025/0209909 A1
(43) Pub. Date: Jun. 26, 2025

(54) SYSTEM AND METHOD FOR DETERMINING TRAFFIC DATA

(71) Applicant: HERE Global B.V., Eindhoven (NL)

(72) Inventors: Amarnath NAYAK, Mumbai (IN); Leon STENNETH, Chicago, IL (US)

(21) Appl. No.: 18/394,603

(22) Filed: Dec. 22, 2023

(51) Int. Cl. G08G 1/01; G01C 21/36

(52) U.S. Cl. CPC G08G 1/0133; G01C 21/3691; G08G 1/0129

(57) ABSTRACT

A system and a method for determining lane-level traffic data is provided. The system is configured to obtain sensor data of each of a plurality of vehicles associated with a lane segment. The sensor data comprises at least one of: forward distance data of one or more vehicles in vicinity of each of the plurality of vehicles in the lane segment, or backward distance data of the one or more vehicles in the vicinity of each of the plurality of vehicles in the lane segment. The system is configured to determine lane distance data for the lane segment based on the sensor data, wherein the lane distance data comprises forward average distance data, or backward average distance data. The system is configured to determine traffic data for the lane segment based on the lane distance data.

### TECHNOLOGICAL FIELD

The present disclosure generally relates to determining traffic data for map databases, and more particularly relates to systems and methods for determining lane-level traffic data for updating map databases.

### BACKGROUND

Traffic data aims to provide real-time information relating to traffic to help users to be better informed about traffic conditions. The traffic data also helps users to track traffic information to meet everyday mobility and navigation requirements. In addition, analytical techniques may be applied on the traffic data to derive, for example, travel times, travel distance, favorable travel route, traffic incidents, traffic flows, traffic delays, driving behavior guide or navigation instructions, any real-time change along the route, and so forth. For example, the traffic data may be used to derive real-time changes in traffic conditions, such as delays due to dynamic factors, such as congestion, construction, accidents, special events (e.g., concerts, sporting events, festivals), weather conditions (e.g., rain, snow, tornado), and so on.

To this end, the traffic data identifying traffic conditions may be generated based on probes, such as probe devices and/or probe vehicles. For example, the probes may be individual driver devices, connected vehicles and/or detection equipment near a road. Typically, traffic conditions are displayed on navigation maps using a signal color. As may be noted, a first signal color, such as red color may indicate heavy traffic, whereas a second signal color, such as green color may indicate no traffic or free traffic flow.

However, traffic data only provides information along road or link-level. Owing to dynamic traffic behavior, traffic conditions, traffic delays and traffic average speeds may vary significantly across the different lanes on a same road or link segment. To this end, the traffic data fails to take lane-level traffic information into consideration for providing traffic conditions and generating navigation instructions.

Therefore, use of road or link-level traffic data may not be suitable for providing efficient and accurate navigation services.

### BRIEF SUMMARY OF SOME EXAMPLE EMBODIMENTS

In order to solve the foregoing problem, the present disclosure may provide a system, a method and a computer programmable product that generates accurate lane-level traffic data for efficient navigation services. The techniques disclosed in the present disclosure enable lane-level mapping of vehicles to determine average distance between vehicles in each of the plurality of lanes of the link segment. In this manner, the techniques disclosed in the present disclosure enable to generate lane-level traffic data to help derive lane-level traffic conditions. This further enables to provide lane-level navigation instructions to ensure efficient and precise navigation of vehicles on the plurality of lanes. In addition, providing lane-level traffic conditions also ensures proper distribution of traffic across the plurality of lanes and better traffic management. To this end, the lane-level traffic management may enhance optimization of traffic infrastructure, especially for autonomous vehicles.

The system and the method described herein provide generation of lane-level traffic data based on average distance between vehicles on lanes. In particular, the lane-level traffic data may enable traffic management by controlling proper distribution of influx of traffic or incoming traffic on different lanes of a link segment. In addition, the lane-level traffic data may enable users to track lane level traffic conditions or lane-level congestion, for example, by showing real-time lane-level traffic conditions using signal colors. In certain cases, the lane-level traffic data may also enable drivers or controllers of autonomous vehicles to plan actions, such as overtaking. This is highly advantageous especially in the case of autonomous vehicles, which benefit from getting accurate and up-to-data lane-level traffic data in real-time. This further ensures faster decision making while driving and thus, safer, and reliable navigation. Even in the case of semi-autonomous or manually driven vehicles, the correct and complete lane-level traffic data ensures better and reliable navigation. Further, the accurate lane-level traffic data for different lanes of different links may be used to update a map database and thus improve the quality of the map data, which is helpful for all navigation services provided by using the map database.

A system, a method and a computer programmable product are provided for implementing the process for generating lane-level traffic data.

In one aspect, a system for generating lane-level traffic data is disclosed. The system comprises a memory configured to store computer executable instructions, and one or more processors configured to execute the instructions. The one or more processors are configured to obtain sensor data of each of a plurality of vehicles associated with a lane segment. The sensor data comprises at least one of: forward distance data of one or more vehicles in vicinity of each of the plurality of vehicles in the lane segment, and backward distance data of the one or more vehicles in the vicinity of each of the plurality of vehicles in the lane segment. The one or more processors are configured to determine lane distance data for the lane segment based on the sensor data, wherein the lane distance data comprises forward average distance data, and backward average distance data. The one or more processors are configured to determine traffic data for the lane segment based on the lane distance data.

In additional system embodiments, to obtain the sensor data of the plurality vehicles associated with the lane segment, the one or more processors are further configured to obtain lane location data relating to the lane segment based on map data, determine vehicle location data for each of the plurality of vehicles based on the obtained sensor data, and generate map matched data for each of the plurality of vehicles based on the lane location data and the corresponding vehicle location data. The map matched data indicates a matching between the vehicle location data and the lane location data. The one or more processors are further configured to determine the plurality of vehicles of the map matched data as the vehicles corresponding to the lane segment.

In additional system embodiments, the one or more processors are further configured to determine an average distance threshold for the lane segment based on map data, determine a traffic congestion value for the lane segment based on a comparison of the average distance threshold and the lane distance data, and update a map database based on the comparison.

In additional system embodiments, the one or more processors are further configured to determine a color for displaying the lane segment on a map based display interface based on the traffic congestion value, and cause to display the lane segment in association with the determined color during a time period.

In additional system embodiments, the one or more processors are further configured to generate updated navigation instructions for a vehicle travelling in the lane segment to re-route the vehicle, on determining the traffic congestion value to be greater than a predefined threshold.

In additional system embodiments, the traffic data comprises at least one of: a traffic congestion value for the lane segment, a vehicle density value for the lane segment, or a combination thereof.

In additional system embodiments, the one or more processors are further configured to determine an average error value associated with at least one of: the forward distance data and the backward distance data and update the lane distance data for the lane segment based on the average error value.

In additional system embodiments, the one or more processors are further configured to combine the forward average distance data and the backward average distance data based on corresponding average error value and determine the lane distance data for the lane segment based on the combination.

In additional system embodiments, the one or more processors are further configured to obtain historical lane distance data for the lane segment. The historical lane distance data comprises at least one of: historical forward average distance data, and historical backward average distance data. The one or more processors are further configured to determine the traffic data for the lane segment during a first time period based on the lane distance data and the historical lane distance data.

In additional system embodiments, the one or more processors are further configured to determine traffic data for one or more lane segments associated with a link segment based on corresponding lane distance data and generate navigation instructions for regulating traffic on the one or more lane segments based on the corresponding traffic data.

In additional system embodiments, the one or more processors are further configured to determine forward vehicle distance data for a vehicle from the plurality of vehicles based on the sensor data. The forward vehicle distance data comprising at least a first distance between the vehicle and a first forward vehicle, and a second distance between the first forward vehicle and a second forward vehicle. The one or more processors are further configured to generate navigation instructions for the vehicle for overtaking the first forward vehicle, on determining the first distance to be less than a first threshold and the second distance to be greater than a second threshold.

In another aspect, a method for determining lane-level traffic data is disclosed. The method comprises obtaining sensor data of each of a plurality of vehicles associated with a lane segment. The sensor data comprising at least one of: forward distance data of one or more vehicles in vicinity of each of the plurality of vehicles in the lane segment, and backward distance data of the one or more vehicles in vicinity of each of the plurality of vehicles in the lane segment. The method comprises determining lane distance data for the lane segment based on the sensor data, wherein the lane distance data comprises forward average distance data, and backward average distance data. The method comprises determining traffic data for the lane segment based on the lane distance data.

In yet another aspect, a computer program product comprising a non-transitory computer readable medium having stored thereon computer executable instructions which when executed by at least one processor, cause the processor to conduct operations for determining lane-level traffic data. The operations comprise obtaining sensor data of each of a plurality of vehicles associated with a lane segment. The sensor data comprising at least one of: forward distance data of one or more vehicles in vicinity of each of the plurality of vehicles in the lane segment, and backward distance data of the one or more vehicles in vicinity of each of the plurality of vehicles in the lane segment. The operations further comprise determining lane distance data for the lane of the link segment based on the sensor data, wherein the lane distance data comprises forward average distance data, or backward average distance data. The operations further comprise determining traffic data for the lane segment based on the lane distance data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a block diagram of a network environment where a system for determining lane-level traffic data is implemented, in accordance with an embodiment of the present disclosure;

FIG. 2 illustrates a block diagram of the system for determining traffic data, in accordance with an example embodiment of the present disclosure;

FIG. 3A illustrates an example environment where the system for determining traffic data is implemented, in accordance with an example embodiment of the present disclosure;

FIG. 3B illustrates another example environment where the system for determining traffic data is implemented, in accordance with an example embodiment of the present disclosure;

FIG. 4 illustrates a method for regulating traffic on lane segments based on corresponding traffic data, in accordance with an example embodiment of the present disclosure;

FIG. 5 illustrates an example method for determining traffic data based on historical distance data, in accordance with an example embodiment of the present disclosure; and

FIG. 6 illustrates an example method for determining traffic data of a lane segment, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

### Definitions

The term “road” may refer to a way leading a traveler from one location to another. The road may have a single lane or multiple lanes.

The term “link” may refer to a topology of segments of a road that start, end, and meet at nodes (such as, intersections where two or more roads join). In an example, a link may have one or more lanes.

The term “lane” may refer to a division of a link marked off with painted lines and intended to separate single lines of traffic according to speed or direction.

The term “lane segment” may refer to a part or a portion of a lane. Similarly, the term “link segment” may refer to a part or a portion of the link segment. In an example, a length of the lane segment and/or the link segment may be predefined. For example, the length of the lane segment and/or the link segment may be, but is not limited to, 500 meters, 1 kilometers (km), 3 kms, 5 kms, 10 kms, and so forth.

The term “route” may refer to a path from a source location to a destination location which includes multiple links.

The term “traffic data” refers to information indicating change in travel speeds on specific road segments over time. In an example, the traffic data may be indicative of a number of vehicles on the road segment at a given time that will affect the traffic condition on the road segment. The traffic condition may indicate if the road segment is heavily congested or has heavy traffic, has moderate traffic, or has no traffic. For example, the traffic data may be analyzed to derive travel times, which in turn is used for selecting a favorable route for navigation and generating navigation instructions for users. In an example, the traffic data for road segments on a route between a source location and a destination location may have to be accounted for, for determining travel times while travelling from the source location to the destination location. Moreover, the traffic data may have to be updated in real-time to ensure efficient routing by saving time by avoiding the slower and/or more congested road segment between the source location and the destination location. In an example, the traffic data comprises at least one of: a traffic congestion value for a lane or road segment, a vehicle density value for the lane or road segment, and travel speed of vehicles on the lane or road segment.

The term “sensor data” refers to data or measurement obtained from a sensor. Pursuant to present disclosure, the sensor data may be obtained from one or more sensors onboard one or more corresponding vehicles. For example, the sensor data obtained from a vehicle may include, but is not limited to, location data, speed data, acceleration data, one or more images identifying surroundings or vicinity of a vehicle, distance between a vehicle and its neighboring vehicles, and so forth. In an example, the sensor data may be indicative of parameters associated with the vehicle, parameters associated with one or more road segment travelled by the vehicle, and parameters associated with traffic on one or more road segments travelled by the vehicle.

### End of Definitions

A system, a method, and a computer program product are provided for determining lane-level traffic data of a lane segment. The conventional traffic data generated based on probes may be for link-level. However, using link-level traffic data for generating navigation instructions for routing of vehicles may be ineffective. As may be noted, a link segment may include a plurality of lanes, such as multiple lanes for upstream traffic flow and multiple lanes for downstream traffic flow. To this end, some lanes from the multiple lanes in a particular direction may have more traffic as compared to the traffic in other lanes. Further, incoming traffic, such as an incoming vehicle having link-level traffic data may join a lane having higher traffic. As a result, traffic in some of the lanes may keep on increasing resulting in uneven distribution of traffic across the multiple lanes and sub-optimal use of road infrastructure for traffic management.

Further, disparity in lane level traffic distribution may cause drivers to change lanes frequently resulting in an increased number of accidents. In certain cases, owing to lack of lane-level traffic data, a driver may be unable to change lanes, for example, when trying to change lanes for exiting a link segment. For example, if a lane adjacent to a current lane of the vehicle may have high traffic and an exit lane may be after or next to the adjacent lane, then the driver may either have to skip the exit causing re-routing, driver inconvenience and possibly increased travel time, or the driver may have to hold the traffic in the adjacent lane to cross the adjacent lane causing standing traffic. As may be understood, either of the two cases may be undesirable. To this end, prior information of lane-level traffic data is crucial for ensuring optimized traffic management, optimal use of road infrastructure and ensuring driver comfort.

Various embodiments are provided herein for determining lane-level traffic data, such that lane-level traffic data may be used to generate lane-level navigation instructions. The lane-level traffic data may be used for accurate depiction of lane-level traffic conditions, such as lane-level traffic congestion. Further, the lane-level traffic data may be used for regulating traffic on lane segments and providing accurate information to drivers. In certain cases, the lane-level traffic data may also be used for determining a suitable time for driving actions, such as lane changing, overtaking, etc. In this manner, map databases storing lane-level traffic data and navigation related operations using the lane-level traffic data may be improved.

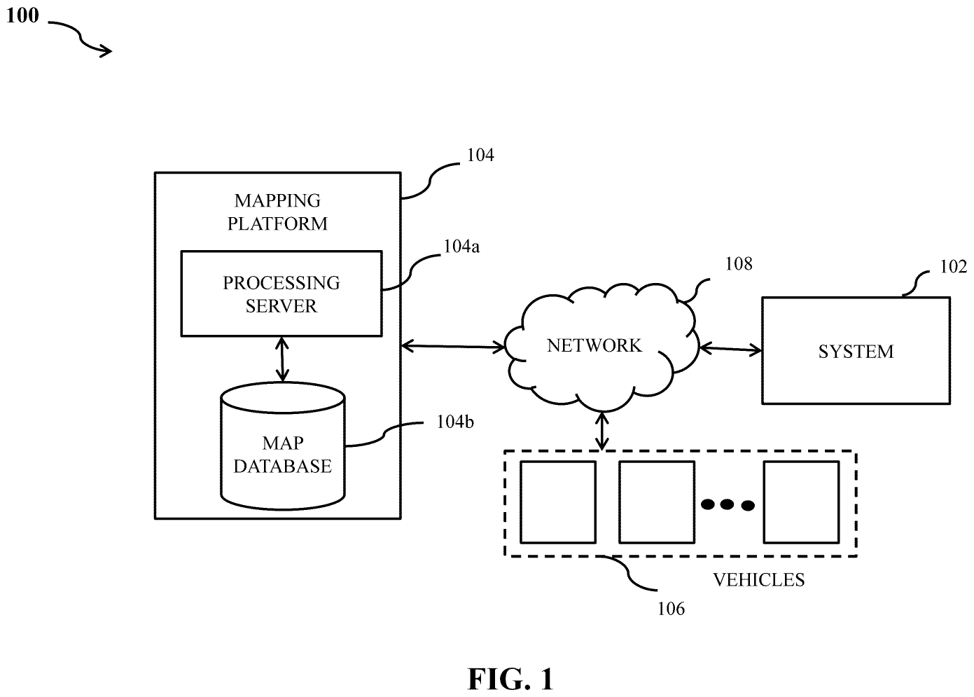

FIG. 1 illustrates a block diagram of a network environment 100 where a system 102 for determining lane-level traffic data is implemented, in accordance with an example embodiment. As shown in FIG. 1, the network environment 100 may include the system 102, and a mapping platform 104. The mapping platform 104 may further include a processing server 104a and a map database 104b. The network environment 100 may further include vehicles 106, and a network 108.

In an embodiment, the system 102 is coupled to one or more user equipment, for example, as a part of an in-vehicle navigation system, a navigation app in a mobile device and the like, associated with the vehicles 106. In this regard, the system 102 is communicatively coupled to the components shown in FIG. 1 to carry out the desired operations and wherever required modifications may be possible within the scope of the present disclosure.

In some example embodiments, the vehicles 106 may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors (such as accelerometer), an image sensor (such as camera), a display enabled user interface (such as a touch screen display), and other components as may be required for specific functionalities of the vehicles 106. In some example embodiments, user equipment is associated, coupled, or otherwise integrated with the vehicles 106, such as an advanced driver assistance system (ADAS), a personal navigation device (PND), a portable navigation device, an infotainment system and/or other device that may be configured to provide route guidance and navigation related functions to the user.

In some example embodiments, the vehicles 106 may generate sensor data while travelling along a link segment or a lane segment on a link. In accordance with an embodiment, the sensor data may be generated by the vehicles 106, when sensor(s) on-board the vehicles 106 may sense information relating to, for example, traffic in vicinity of the vehicles and road condition, and so forth. In accordance with an embodiment, the vehicles 106 may generate the sensor data in real-time and transmit it to the system 102 and/or the mapping platform 104 to report traffic conditions. In certain cases, each of the vehicles 106 is configured to send updated sensor data periodically, for example, every five seconds, every thirty seconds, every minute, and so forth.

In an example, user equipment may be installed in each of the vehicles 106 and is configured to detect sensor data and traffic conditions on link segments and/or road segments by using image based sensors installed in the vehicles 106. For example, the image based sensors may include cameras, or LiDAR. In an example, the image based sensors may be installed on link segments or roads, and the image sources may detect sensor data and traffic conditions for corresponding location on the links segments or roads. The image based sensors and/or the user equipment may transmit the detected sensor data and traffic condition to the system 102, which processes the detected data to generate traffic data.

In an example embodiment, the system 102 may be onboard a vehicle, such that the system 102 may be a navigation system installed in the vehicles 106 for determining traffic data and generating navigation instructions. In an example, a vehicle may be an autonomous vehicle, a semiautonomous vehicle, or a manually operated vehicle. In another example embodiment, the system 102 may be the processing server 104a of the mapping platform 104, and therefore may be co-located with or within the mapping platform 104.

The system 102 may be communicatively coupled to the vehicles 106, the image based sensors and the mapping platform 104, via the network 108. In an embodiment, the system 102 may be communicatively coupled to other components not shown on FIG. 1 via the network 108. All the components in the network environment 100 may be coupled directly or indirectly to the network 108. The components described in the network environment 100 may be further broken down into more than one component and/or combined together in any suitable arrangement. Further, one or more components may be rearranged, changed, added, and/or removed.

The system 102 may comprise suitable logic, circuitry, and interfaces that may be configured to determine traffic data for a lane segment. The system 102 is configured to retrieve sensor data and map data corresponding to a lane segment from the map database 104b. In some example embodiments, the system 102 is configured to determine traffic data for a lane segment for enabling precise lane-level routing along a route using the sensor data and map data corresponding to the lane segment. For example, the lane segment may lie on a road network and may cover a predefined distance, i.e., may have a predefined length.

In an example, the map database 104b may contain lane and intersection data records or other data that may represent link in the route, pedestrian lane, or areas in addition to or instead of the vehicle lanes. The lanes and intersections may be associated with attributes, such as geographic coordinates, street names, lane identifier, lane segment identifier, lane traffic direction, address ranges, speed limits, turn restrictions at intersections, and other navigation related attributes, as well as POIs, such as fueling stations, hotels, restaurants, museums, stadiums, offices, auto repair shops, buildings, stores, and parks. The map database 104b may additionally include data about places, such as cities, towns, or other communities, and other geographic features such as, but not limited to, bodies of water, and mountain ranges.

In some example embodiments, images received from the image based sensors may be stored within the map database 104b of the mapping platform 104. In certain cases, the mapping platform 104, using the processing server 104a, may suitably process the received images.

The embodiments disclosed herein address the aforementioned problems relating to conventional traffic data relating to link segments. In particular, traffic data generated on link-level fails to provide lane-level traffic information to users and/or navigation map developers. As a result, navigation instructions are provided to users on link-level thereby affecting proper distribution of traffic across multiple lanes of a link. In addition, link-level traffic data also fails to provide analytical data relating to driving operations on lane level. In other words, link-level traffic data fails to provide analytics relating to, for example, lane changing, overtaking, safe exit from a lane, etc. In order to overcome the aforementioned problems, the system 102 is provided for determining lane-level traffic data.

In operation, the system 102 is configured to obtain sensor data of each of a plurality of vehicles associated with a lane segment. For example, the vehicles 106 may be associated with the lane segment. That is, the vehicles 106 may be travelling on the lane segment during a time period. Subsequently, the vehicles 106, particularly one or more sensors on-board the vehicles 106 may transmit the sensor data to the system 102 or the mapping platform 104. In an example, one or more image sensors, such as cameras and one or more distance sensors, such as LIDARs on-board the vehicles 106 may provide the sensor data to the system 102. In certain cases, the system 102 may query the mapping platform 104 to retrieve the sensor data.

In an embodiment, the sensor data may include traffic information relating to the lane segment. In an example, the sensor data may include at least one of: forward distance data of one or more vehicles in vicinity of each of the plurality of vehicles in the lane segment, and backward distance data of the one or more vehicles in the vicinity of each of the plurality of vehicles in the lane segment. For example, a vehicle from the vehicles 106 in the lane segment may sense a distance between the vehicle and a corresponding forward vehicle. The forward vehicle may be ahead of the vehicle in a direction of traffic flow on the lane segment. Such distance may indicate forward distance for the vehicle. In this manner, each of the vehicles 106 may sense forward distance associated with corresponding forward vehicles. Such forward distance sensed by the vehicles 106 may be transmitted to the system 102 as the forward distance data. Similarly, a vehicle from the vehicles 106 in the lane segment may sense a distance between the vehicle and a corresponding backward vehicle. The backward vehicle may be behind the vehicle in the direction of traffic flow on the lane segment. Such distance may indicate backward distance for the vehicle. In this manner, each of the vehicles 106 may sense backward distance associated with corresponding backward vehicles. Such backward distance sensed by the vehicles 106 may be transmitted to the system 102 as the backward distance data.

Further, the system 102 is configured to determine lane distance data for the lane segment based on the sensor data. The lane distance data comprises forward average distance data, and backward average distance data. In an example, the forward average distance data is determined based on the forward distance data received from the vehicles 106. For example, the forward average distance data may indicate an average distance for the vehicles 106 and corresponding forward vehicles on the lane segment. In a similar manner, the backward average distance data is determined based on the backward distance data received from the vehicles 106. The backward average distance data may indicate an average distance for the vehicles 106 and corresponding backward vehicles on the lane segment.

Thereafter, the system 102 is configured to determine traffic data for the lane segment based on the lane distance data. It may be noted that the traffic data for the lane segment indicates an amount of traffic, such as vehicle density on the lane segment. For example, the traffic data for the lane segment, i.e., the lane-level traffic data may indicate traffic condition, such as a level of congestion on the lane segment. It may be noted that such lane-level traffic data may be determined for each of multiple lane segments of a link segment and for multiple link segments across a road network.

In an example, the map database 104b may be updated based on the determined traffic data to indicate lane-level traffic data. Such lane-level traffic data may ensure generation of precise navigation instructions based on lane-level traffic conditions. As may be noted, the traffic conditions or traffic data is dynamic. To this end, the determined traffic data may be updated in real-time or near real-time, for example, 2 seconds, 5 seconds, 10 seconds, 20 seconds, 30 second, and so forth to provide up-to-date traffic data for navigation-related operations.

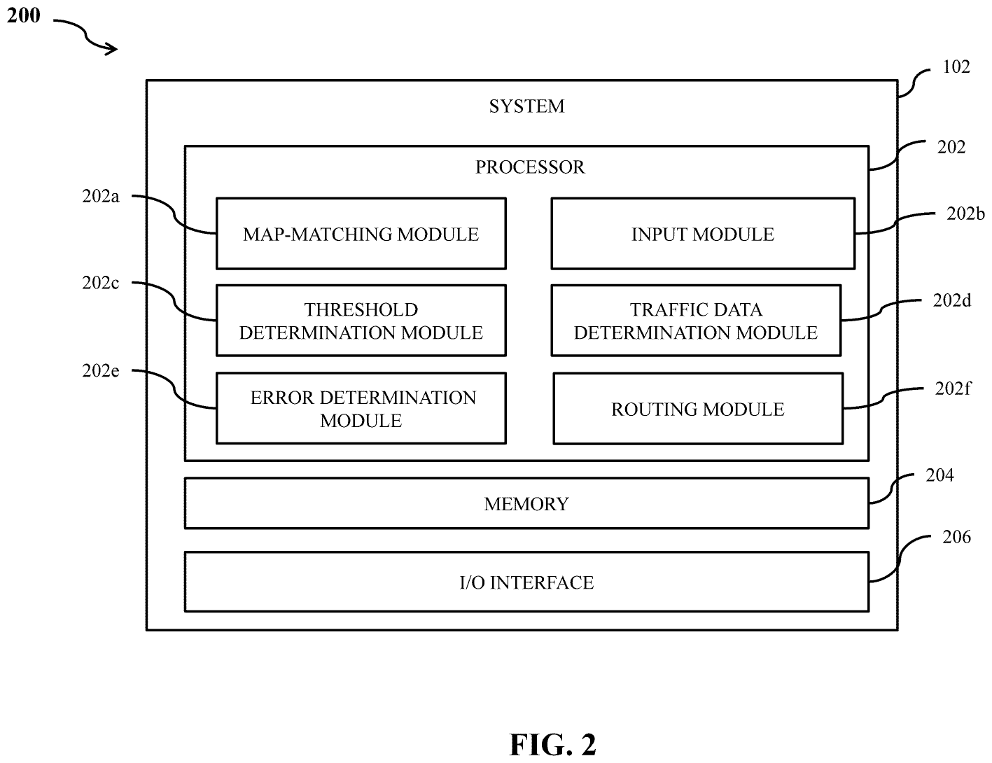

FIG. 2 illustrates a block diagram 200 of the system 102, exemplarily illustrated in FIG. 1 that may be used for determining traffic data, in accordance with an example embodiment. FIG. 2 is explained in conjunction with FIG. 1.

The system 102 may include one or more processors 202 (referred to as a processor 202, hereinafter), a memory 204, and an I/O interface 206. The processor 202 may comprise modules, depicted as a map-matching module 202a, an input module 202b, a threshold determination module 202c, a traffic data determination module 202d, an error determination module 202e and a routing module 202f.

In accordance with an embodiment, the system 102 may store data that may be generated by the modules while performing corresponding operation or retrieved from a database associated with the system 102, such as the map database 104b, in the memory 204. In an example, the data may include sensor data, lane distance data, an average distance threshold, traffic data, map data, probe data, traffic congestion value, a predefined threshold, and navigation instructions.

The processor 202 of the system 102 is configured to obtain the sensor data of the vehicles 106 associated with the lane segment. In particular, the processor 202 may obtain forward distance data of one or more vehicles in vicinity of each of the vehicles 106 in the lane segment and backward distance data of one or more vehicles in the vicinity of each of the vehicles 106 in the lane segment. Further, the processor 202 is configured to determine lane distance data for the lane segment based on the sensor data. The processor 202 is configured to determine traffic data for the lane segment based on the lane distance data. In an example, the traffic data may indicate traffic condition on the lane segment during a given time period. For example, such traffic data may be determined repeatedly to keep on determining updated and real-time traffic data.

The memory 204 of the system 102 is configured to store a dataset (such as, but not limited to, the sensor data, the probe data, and the map data) associated with multiple lane segments within the link segment. In accordance with an embodiment, the memory 204 may include processing instructions for processing the sensor data. The dataset may include real-time data and historical data, from service providers. The memory 204 of the system 102 may be configured to store the sensor data, the lane distance data, forward average distance data, backward average distance data, a traffic congestion value, a vehicle density value, an average distance threshold, processed sensor data, updated navigation instructions, updated map data, and routing related messages.

Pursuant to an example embodiment, the map-matching module 202a is configured to generate lane-level map-matching between the vehicles 106 and a lane segment. For example, some of the vehicles 106 or all of the vehicles 106 may be associated with, i.e., travelling on the lane segment.

In this regard, the map-matching module 202a is configured to identify a link segment of a road network. In an example, the map-matching module 202a may identify the link segment based on map data stored in the map database 104b. The map database may indicate location or geographic region, or area associated with the link segment. For example, the link segment may have a predefined length of, for example, 500 meters, 1 kilometer (km), 2 kms, 5 kms, and so forth. In an example, a number of link segments may be identified. Each of the link segments may be assigned a unique identifier. For example, an identifier may also be assigned to indicate different segments of the link segment having different traffic flow directions, i.e., upstream traffic flow and downstream traffic flow.

Further, for an identified link segment, a number of corresponding lane segments may be identified. In this regard, lane location data relating to a lane segment may be obtained from map database 104b or map data. The lane location data may indicate geographic area, or a set of location points associated with a lane segment lying on the link segment. Moreover, an identifier may be allocated to each of the lane segments associated with the identified link segment.

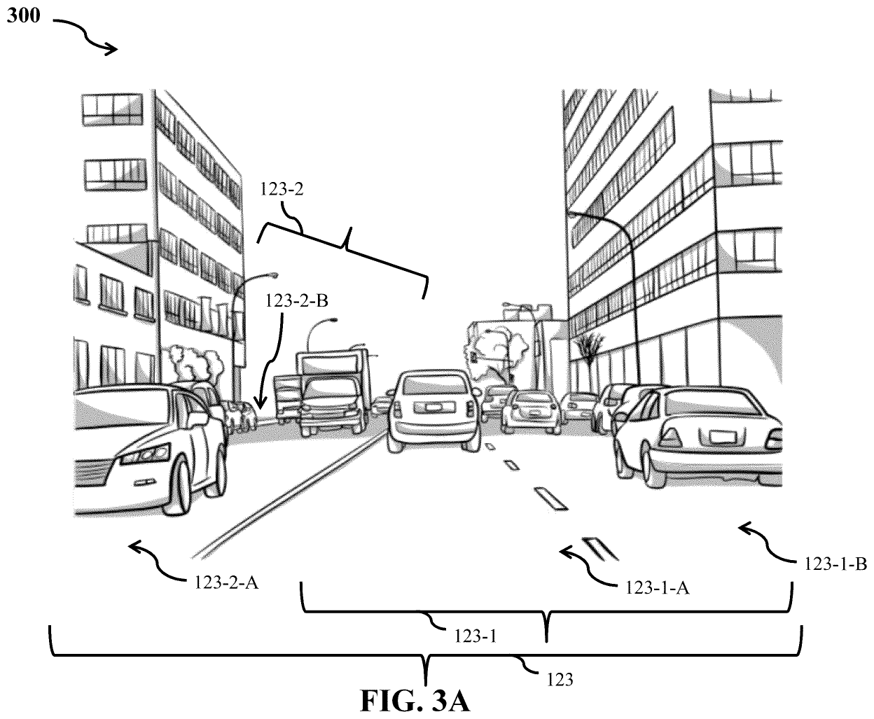

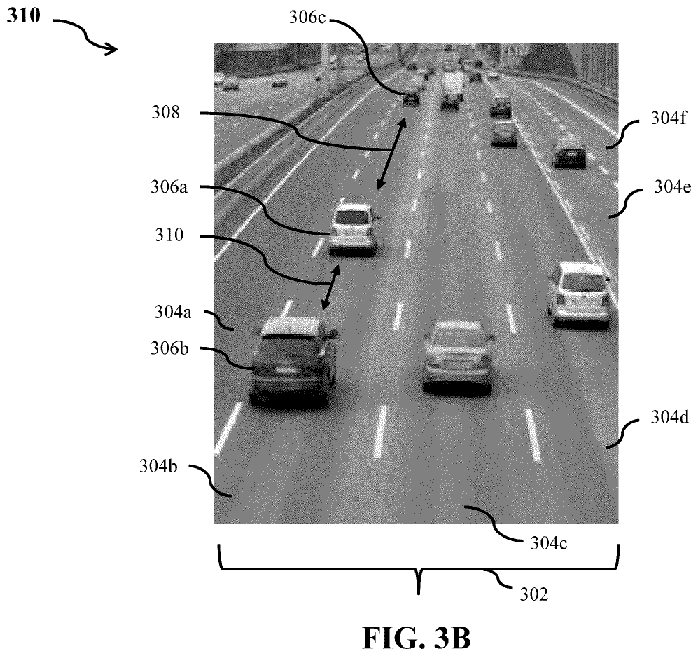

Referring to FIG. 3A, there is shown a schematic illustration 300 of an environment in which the system 102 is implemented, in accordance with an example embodiment. In an example, the system 102 is configured to perform map-matching of traffic data with lane segments of a link segment 123. The map-matching module 202a is configured to allocate an identifier as “123” to the link segment. Further, for upstream traffic flow segment of the link segment, an identifier of “1” may be allocated, whereas for downstream traffic flow segment of the link segment, an identifier of “2” may be allocated. The upstream traffic flow segment and the downstream traffic flow segment may include one or more lane segments. To this end, a first lane segment of the upstream traffic flow segment may be allocated an identifier as “A”, a second lane segment of the upstream traffic flow segment may be allocated an identifier as “B”, a third lane segment of the downstream traffic flow segment may be allocated an identifier as “A”, a fourth lane segment of the downstream traffic flow segment may be allocated an identifier as “B”, and so forth. To this end, the first lane segment may have an associated identifier as 123-1-A, the second lane segment may have an associated identifier as 123-1-B, the third lane segment may have an associated identifier as 123-2-A, and the fourth lane segment may have an associated identifier as 123-2-B. In this manner, different lanes of each of the link segments may be identified.

In an example, the input module 202b is configured to receive input data from one or more sensors. In an example, the one or more sensors may be associated with the vehicles 106, such as sensors on-board the vehicles 106. In another example, the one or more sensors may be installed in vicinity of link segments to obtain sensor data. For example, the one or more sensors may include one or more image sensors, one or more LIDARs, one or more speed sensors, one or more global positioning sensors (GPS), and the like. In an example, sensor data from the vehicles 106 may include corresponding vehicle location data, for example, location coordinates.

Based on the vehicle location data associated with each of the vehicles 106 and identified lane location data associated with the lane segments, the map-matching module 202a may be further configured to generate map matched data for each of the vehicles 106. In an example, a location of a vehicle may be matched with a location associated with one of the lane segments of the link segment based on the lane location data associated with the lane segments and the vehicle location data associated with the vehicle. The map matched data indicates a matching between vehicle location data for each of the vehicles 106 and the lane location data of the lane segments. To this end, each of the vehicles 106 with on-board sensors may be map-matched to the road network. In particular, the map-matching module 202a performs a lane-level map matching to associate a vehicle with a specific lane segment, such as the lane segment 123-1-A. In this manner, the vehicles 106 may be associated with the lane segment 123-1-A. Subsequently, the vehicles 106 of the map matched data for the lane segment 123-1-A are determined as the vehicles 106 corresponding to the lane segment 123-1-A or the vehicles 106 travelling on the lane segment 123-1-A for a given time period.

Returning to FIG. 2, the sensor data received by the input module 202b may also include the forward distance data associated with each of the vehicles 106. The forward distance data may indicate a distance between a vehicle on the lane segment 123-1-A and corresponding one or more forward vehicles in vicinity of the vehicle on the lane segment 123-1-A. In addition, the sensor data may include the backward distance data associated with each of the vehicles 106. The backward distance data may indicate a distance between a vehicle on the lane segment 123-1-A and corresponding one or more backward vehicles in vicinity of the vehicle on the lane segment 123-1-A. In an example, the vicinity for a vehicle under consideration may indicate a distance range or a distance threshold, such that one or more other vehicles which are at a distance within either this distance range or distance threshold, are considered to be vehicles in vicinity of the vehicle. Pursuant to embodiments of the present disclosure, the vehicles in the vicinity of the vehicle under consideration and the vehicle would be associated with a same lane segment. Therefore, the vicinity may be considered as a distance range in a forward direction and/or a backward direction from the vehicle bounded by the distance threshold on the lane segment.

The threshold determination module 202c is configured to determine an average distance threshold for the lane segment, for example, the lane segment 123-1-A, based on the map data. In particular, the average distance threshold may indicate an average distance between vehicles that may be used to determine traffic condition, i.e., a level of traffic congestion of the lane segment 123-1-A. In this regard, the threshold determination module 202c may determine the average distance threshold based on historical data relating to traffic on the lane segment 123-1-A, or historical data indicating congestion on any lane segment similar to the lane segment 123-1-A. In another example, the threshold determination module 202c may determine the average distance threshold based on an area or dimensions of the lane segment 123-1-A, historical vehicle density on the lane segment 123-1-A during a time period, and a historical traffic congestion value during the time period.

In addition, the threshold determination module 202c is configured to determine a predefined threshold for determining a level of traffic congestion on the lane segment 123-1-A. For example, the predefined threshold may indicate a congestion value that would correspond to a moderate level of traffic congestion on a lane segment. Therefore, if traffic congestion value for a lane segment is greater than the predefined threshold, the lane segment may have high traffic congestion, and vice-versa.

Further, the traffic data determination module 202d is configured to determine lane-level traffic data for the lane segment 123-1-A having the associated vehicles 106. First, the lane-level map matching is performed between the lane location data for the lane segment 123-1-A and the vehicle location data for the vehicles 106 to identify the vehicles 106 travelling on the lane segment 123-1-A. Further, the traffic data determination module 202d may determine nearest vehicle in the forward and the backward direction for each of the vehicles 106 based on corresponding sensor data during a given time period. In this manner, the traffic data determination module 202d may identify a forward vehicle and a backward vehicle for each of the vehicles 106 on the lane segment 123-1-A during the given time period. Thereafter, the traffic data determination module 202d may extract forward distance data relating to a forward vehicle and backward distance data relating to a backward vehicle for each of the vehicles 106 on the lane segment during the given time period.

The traffic data determination module 202d is configured to determine lane distance data for the lane segment 123-1-A based on the sensor data. In particular, the traffic data determination module 202d may determine forward average distance data based on the forward distance data associated with corresponding forward vehicle for each of the vehicles 106. In an example, the forward average distance data may indicate an average distance value between the vehicles 106 and corresponding forward vehicles on the lane segment 123-1-A. Similarly, the traffic data determination module 202d may determine backward average distance data based on the backward distance data associated with corresponding backward vehicle for each of the vehicles 106. In an example, the backward average distance data may indicate an average distance value between vehicles and corresponding backward vehicles on the lane segment 123-1-A.

For example, when a forward vehicle and/or a backward vehicle is identified for each of the multiple vehicles 106 associated with a lane segment, then each of the vehicles 106 having corresponding forward vehicle may provide forward distance data and each of the vehicles 106 having corresponding backward vehicle may provide backward distance data. Thus, the forward average distance data indicates a mathematical average of the forward distance data values obtained from all of the vehicles 106 for the lane segment. Similarly, the backward average distance data indicates a mathematical average of the backward distance data values obtained from all of the vehicles 106 for the lane segment. For example, this mathematical average may be a mean value, a median value, a mode value, and the like.

In certain cases, the error determination module 202e is configured to determine an error value associated with the forward distance data, and/or the backward distance data. In an example, a vehicle on the lane segment 123-1-A may transmit forward distance data and backward distance data relating to a corresponding forward vehicle and a corresponding backward vehicle, respectively. To this end, the error determination module 202e may determine a standard error value for the vehicle, particularly, a standard error value for the forward distance data and a standard error value for the backward distance data. In an example, a function for determining the standard error value, represented as SE, may be denoted as:

$$S E = \frac{σ}{\sqrt{n}}$$

where σ represents standard deviation of the vehicle and n represents a total number of vehicles on the lane segment 123-1-A.

To this end, a standard error value may be determined for the forward distance data and/or the backward distance data for each of the vehicles 106. Thereafter, an average error value may be determined for the forward distance data of each of the vehicles 106 in the lane segment 123-1-A and the backward distance data of each of the vehicles 106 in the lane segment 123-1-A.

For example, forward distance data and a standard error value associated with a first vehicle from the vehicles 106 on the lane segment 123-1-A may be 2 meters and 0.8 meters, respectively. Moreover, forward distance data and a standard error value associated with a second vehicle from the vehicles 106 on the lane segment 123-1-A may be 3 meters and 0.5 meters, respectively; forward distance data and a standard error value associated with a third vehicle from the vehicles 106 on the lane segment 123-1-A may be 1 meter and 0.5 meters, respectively; and forward distance data and a standard error value associated with a fourth vehicle from the vehicles 106 on the lane segment 123-1-A may be 2 meters and 0.25 meters, respectively. For example, the forward distance data associated with a vehicle may indicate a distance between the vehicle from the vehicles 106 and a corresponding forward vehicle. In such a case, the traffic data determination module 202d may determine the forward average distance data as 2 meters. Moreover, the error determination module 202e may determine an average error value for the forward distance data of the vehicles 106 in the lane segment 123-1-A as 0.51. In a similar manner, the traffic data determination module 202d may determine the backward average distance data based on the backward distance data transmitted by the vehicles 106. In addition, the error determination module 202e may determine an average error value for the backward distance data of the vehicles 106 in the lane segment 123-1-A.

In accordance with an embodiment, the traffic data determination module 202d is configured to update the lane distance data based on the average error value for the forward distance data and the backward distance data. In an example, the forward average distance data, or backward average distance data may be updated to increase its accuracy based on the average error value. In an example, if a standard error value for a forward distance data or a backward distance data is greater than an error threshold, then such forward distance data or a backward distance data may be discarded, i.e., the forward distance data or the backward distance data may not be used for determining the lane distance data. In another example, based on a standard error value for a forward distance data or a backward distance data, the forward distance data or the backward distance data may be modified or updated to a value that may reduce a new standard error value for the updated forward distance data or the backward distance data. In yet another example, the traffic data determination module 202d may fuse or combine the forward average distance data and the backward average distance data for the lane segment 123-1-A based on the corresponding average error value to determine the lane distance data. In this regard, the forward average distance data and the backward average distance data may be fused such that the forward average distance data and the backward average distance data are inversely proportion to corresponding average error value to determine the lane distance data. In this manner, updated lane distance data may be determined.

Further, the traffic data determination module 202d is configured to determine traffic data for the lane segment 123-1-A based on the lane distance data. For example, the traffic data comprises a traffic congestion value for the lane segment 123-1-A, a vehicle density value for the lane segment 123-1-A, or a combination thereof.

In an example, the traffic data determination module 202d is configured to compare the lane distance data with the average distance threshold determined by the threshold determination module 202c. In particular, based on a comparison of the lane distance data, the traffic data determination module 202d may determine a traffic congestion value and/or a vehicle density value for the lane segment 123-1-A during the given time period. In an example, the traffic congestion value may be a numerical value, an alpha-numeric value, a score, a rating, a grade, and so forth. Moreover, the vehicle density value may be represented as number of vehicles within a given unit of area.

Pursuant to present examples, the traffic congestion value may be a numerical score defined within a range of ‘0’ to ‘10’. In such a case, if the average distance threshold is greater than the lane distance data then the traffic congestion value may be less than 5, for example, 3, indicating low traffic or free flow. However, if the average distance threshold is less than the lane distance data then the traffic congestion value may be greater than 5, for example, 7, indicating high traffic or traffic congestion. To this end, the traffic congestion value to be greater than or equal to 5 may indicate high congestion on the lane segment 123-1-A, whereas the traffic congestion value to be less than 5 may indicate low congestion or free traffic flow on the lane segment 123-1-A during the given time period. In this regard, the value “5” may indicate the predefined threshold for determining a level of congestion on the lane segment 123-1-A.

In another example, the traffic data determination module 202d is configured to determine the traffic data in terms of a vehicle density during the given time period based on a number of the vehicles 106 on the lane segment 1230-1-A. In such a case, the traffic data determination module 202d may be configured to retrieve a vehicle density threshold that may be determined by the threshold determination module 202c. The vehicle density threshold may indicate an average number of vehicles within a unit of area based on historical traffic data and/or historical vehicle density on the lane segment 123-1-A. Based on a comparison between the vehicle density during the given time period and the vehicle density threshold, the traffic data determination module 202d may determine the traffic condition. For example, if the vehicle density during the given time period is greater than or equal to the vehicle density threshold, the traffic condition may indicate high congestion and traffic congestion value may be determined as high, such as greater than or equal to 5. Alternatively, if the vehicle density during the given time period is less than the vehicle density threshold, the traffic condition may indicate low congestion or free traffic and traffic congestion value may be determined as low, such as less than 5.

In an example, the traffic data determination module 202d may also store the received forward distance data, the backward distance data, the determined lane distance data, and the determined traffic data within the map database 104b. Subsequently, the traffic data determination module 202d may update the map database 104b based on the determined traffic data, i.e., the traffic congestion value and/or the vehicle density value. As a result, the updated map database 104b may indicate real-time lane-level traffic data for the lane segment 123-1-A during the given time period. Although the embodiments of the present examples are defined in terms of determining traffic data for the lane segment 123-1-A, however, this should not be construed as a limitation. In other embodiments of the present disclosure, the techniques described herein may be used to determine lane-level traffic data for each of the lane segments of the link segment 123, as well as each of lane segments of other identified link segments.

In an example, the lane-level traffic data for the lane segment 123-1-A from the updated map database 104b and/or the traffic data determination module 202d may then be fed to the routing module 202f. The routing module 202f is configured to generate user readable or user-understandable navigation instructions, such as routing messages, notifications, warning messages, audio instructions etc., based on the traffic congestion value and/or the vehicle density value for the lane segment during the given time period. The routing module 202f may send or push the routing messages to user equipment, such as user equipment on-board the vehicles 106, to enable routing of the vehicles 106. The routing module 202f may also send or push routing messages to other user equipment associated with vehicles that are not travelling on the lane segment 123-1-A to manage or plan a route based on lane-level traffic data.

The processor 202 may retrieve computer executable instructions that may be stored in the memory 204 for execution of the computer executable instructions. The memory 204 may store the received sensor data associated with the vehicles 106 of the lane segment. In accordance with an embodiment, the processor 202 may be configured to retrieve input (such as, real-time sensor data, historical probe data, real-time probe data, map data indicating map attributes associated with plurality of link segments and lane segments, and historical traffic data) from background batch data services, streaming data services or third party service providers, and renders output, such as, the traffic data for the lane segment during the given time period, the traffic congestion value during the given time period, and the vehicle density during the given time period, navigation instructions, updated map data, and notification associated with the processing of sensor data for use by an end user on the vehicles 106 through the I/O interface 206.

FIG. 3B illustrates an example environment 310 where the system 102 for determining traffic data is implemented, in accordance with an embodiment of the present disclosure. As shown in FIG. 3B, the environment 310 includes a link segment 302. The link segment 302 includes plurality of lane segments, depicted as lane segments 304a, 304b, 304c, 304d, 304e and 304f (collectively referred to as lane segments 304, hereinafter). The lane segments 304 may correspond to the same traffic flow direction, such as upstream traffic flow on the link segment 302. However, such illustration of the lane segments 304 of the link segment 302 relating to the upstream traffic flow direction should not be construed as a limitation. In another embodiment of the present disclosure, the link segment 302 may include lane segments relating to downstream traffic flow direction. In yet another embodiment of the present disclosure, the link segment 302 may include lane segments 304 relating to the upstream traffic flow direction as well as lane segments relating to the downstream traffic flow direction.

Continuing further, the lane segments 304 of the link segment 302 may have vehicles thereon. For example, each of the lane segments 304 may have corresponding vehicles travelling along the lane segments 304. For example, vehicles 306a, 306b and 306c (collectively referred to as vehicles 306, hereinafter) may be travelling on the lane segment 304b during a time period. To this end, distribution of traffic, i.e., number of vehicles travelling on different lane segments may not be even. For example, certain lane segments, such as the lane segments 304b, 304c and 304d, may have a greater number of vehicles, whereas certain lane segments, such as the lane segments 304a, 304e and 304f, may have a smaller number of vehicles. Therefore, the vehicles travelling on the congested lane segments, i.e., the lane segments 304b, 304c and 304d, may face challenges while navigating through traffic and increased travel times. Moreover, drivers of the vehicles on the lane segments 304b, 304c and 304d may frequently change lanes, thereby increasing risks of accidents. Further, due to improper traffic distribution across the lane segments 304, traffic infrastructure may not be appropriately and optimally used.

To this end, lane-level traffic data, for example, for the lane segment 304b is determined. In this regard, during the time period, the system 102 or the processor 202 is configured to obtain sensor data from the vehicles 306. For example, the sensor data may include corresponding vehicle location data, corresponding forward distance data associated with one or more forward vehicles in vicinity, and corresponding backward distance data associated with one or more backward vehicles in vicinity. In an example, the sensor data obtained from the vehicle 306a may include its vehicle location data (for example, location coordinates), forward distance data associated with one or more forward vehicles in vicinity of the vehicle 306a, and backward distance data associated with one or more backward vehicles vicinity of the vehicle 306a. For example, the one or more forward vehicles in the vicinity of the vehicle 306a may be the vehicle 306b and other vehicles on other lane segments, wherein the other vehicles are ahead of the vehicle 306a in the upstream traffic flow direction. Similarly, the one or more backward vehicles in vicinity of the vehicle 306a may be the vehicle 306c and other vehicles on other lane segments, wherein the other vehicles are behind the vehicle 306a in the upstream traffic flow direction.

In an example, based on the vehicle location data, the processor 202 may be configured to map-match the vehicle 306a with the lane segment 304b. In this regard, the vehicle location data may be matched with the lane location data or geographic region of the lane segment 304b. Based on such map-matching, the vehicle 306a may be determined to be associated or matched with the lane segment 304b.

Further, in an example, the processor 202 may be configured to determine a nearest forward vehicle and a nearest backward vehicle, such as immediate forward vehicle and immediate backward vehicle for the vehicle 306a based on the sensor data on the matched lane segment 304b. According to the present example, the processor 202 may identify the vehicle 306b as backward vehicle for the vehicle 306a and the vehicle 306c as forward vehicle for the vehicle 306a on the lane segment 304b during the time period. In a similar manner, the vehicle 306a may be identified as forward vehicle for the vehicle 306b, and the vehicle 306a may be identified as backward vehicle for the vehicle 306c.

Subsequently, the processor 202 may obtain forward distance data 308 associated with the vehicle 306a indicating a distance between the vehicle 306a and the vehicle 306c, and backward distance data 310 associated with the vehicle 306a indicating a distance between the vehicle 306a and the vehicle 306b. In a similar manner, forward distance data and backward distance data may also be obtained from other vehicles, i.e., the vehicles 306b and 306c, on the lane segment 304b.

In accordance with an example embodiment, on identifying that the vehicle 306c is the forward vehicle for the vehicle 306a, the processor 202 may set an assumption that the vehicle 306a is backward vehicle for the vehicle 306c. Further, the processor 202 is configured to compare forward distance data obtained from the vehicle 306a with backward distance data obtained from the vehicle 306c. For example, in a case where a difference between the forward distance data of the vehicle 306a and the backward distance data of the vehicle 306c is greater than or equal to a distance threshold, such sample, i.e., obtained sensor data may be dropped and not used for determining the lane distance data for the lane segment 304b. In certain cases, when the difference between the forward distance data of the vehicle 306a and the backward distance data of the vehicle 306c is less than the distance threshold but not zero, an average of the forward distance data and the backward distance data may be used for determining the lane distance data. In an example, the distance threshold may be 100 meters, 500 meters, 1 kilometer, 3 kilometers, 5 kilometers, 10 kilometers, and so forth.

Thereafter, the processor 202 is configured to determine lane distance data for the lane segment 304b. The lane distance data comprises forward average distance data and/or backward average distance data. For example, the processor 202 is configured to determine the forward average distance data for the lane segment 304b during the time period based on the forward distance data, such as the forward distance data 308 obtained from each of the vehicles 306. The processor 202 is configured to determine the backward average distance data for the lane segment 304b during the time period based on the backward distance data, such as the backward distance data 310 obtained from each of the vehicles 306. For example, the forward average distance data may indicate an average clear area or distance that vehicles 306 may have in front of them and the backward average distance data may indicate an average clear area or distance that the vehicles 306 may have behind them.

In an example, the processor 202 may also be configured to determine an average forward error value and an average backward error value that may be used to fuse or combine the forward average distance data and the backward average distance data to generate the lane distance data.

The processor 202 is configured to determine traffic data for the lane segment 304b based on the determined lane distance data. In an example, the traffic data may include traffic congestion value. For example, the processor 202 may be configured to determine the traffic congestion value by comparing the lane distance data with average distance threshold. In particular, the forward average distance data and/or the backward average distance data, which may be updated and fused using average forward error value and average backward error value, may be compared with the average distance threshold. Subsequently, if the lane distance data is greater than the average distance threshold, the traffic congestion value may be determined as high. For example, high traffic congestion value may be greater than or equal to 5 on a scale of 1-10. Alternately, if the lane distance data is less than the average distance threshold, the traffic congestion value may be determined as low. For example, low traffic congestion value may be less than 5 on the scale of 1-10.

Once the traffic data or the traffic congestion value for the lane segment 304b is determined, the map database 104b may be updated to indicate real-time traffic on the lane segment 304b during the time period.

In certain cases, the processor 202 may also be configured to determine a color for displaying the lane segment 304b on a map based display interface, based on the determined traffic congestion value. For example, if the traffic congestion value is between 0-3, a green color may be selected; if the traffic congestion value is between 4-7, a yellow color may be selected; and if the traffic congestion value is between 8-10, a red color may be selected.

To this end, the processor 202 is configured to display the lane segment 304b in association with the determined color during the time period. In this manner, the lane-level traffic data or lane-level traffic congestion value may be provided to end-user. For example, such map may be displayed on a display interface of user equipment associated with the vehicles 306 or 106, drivers of the vehicles 306, and other users that may plan to travel along the link segment 302.

It may be noted that such lane-level traffic data may be determined for each of the lane segments 304. Subsequently, a color associated with traffic congestion values for each of the lane segments 304 may be displayed on display interfaces of user equipment associated with the vehicles 306 and other vehicles on the lane segments 304. Using lane-level traffic, route planning and/or generation of navigation instructions may be performed on lane-level. This may ensure optimal utilization of traffic infrastructure. Further, having prior knowledge of lane-level traffic congestion may enable drivers to choose a favorable lane so that user frustration and need for frequent lane changing is avoided.

In accordance with an example embodiment, the processor 202 may be configured to determine forward vehicle distance data for a vehicle, say the vehicle 306a from the vehicles 306 based on the sensor data. The forward vehicle distance data comprises a first distance between the vehicle 306a and a first forward vehicle, say the vehicle 306c For example, the first distance may correspond to forward distance data obtained from the vehicle 306a, backward distance data obtained from the vehicle 306c, or an average thereof. In addition, the forward vehicle distance comprises a second distance between the first forward vehicle or the vehicle 306c and a second forward vehicle (not shown). For example, the second forward vehicle may be a vehicle ahead of the vehicle 306c in the upstream traffic direction during the time period. Subsequently, the second distance may correspond to forward distance data obtained from the vehicle 306c, backward distance data obtained from the second forward vehicle, or an average thereof.

Thereafter, the processor 202 may be configured to generate navigation instructions for the vehicle 306a for overtaking the first forward vehicle, i.e., the vehicle 306c, when the first distance is less than a first threshold and the second distance is greater than a second threshold. In other words, if the first distance between the vehicle 306a and the vehicle 306c is less and the second distance between the vehicle 306c and the second forward vehicle is high, the vehicle 306a may be able to overtake the vehicle 306c easily without changing corresponding lane segment 304b of travel. In an example, the navigation instructions for the vehicle 306a for overtaking the vehicle 306c may also be determined based on speed associated with the vehicles 306a and 306c. For example, if the speed of the vehicle 306c may be low, navigation instructions for the vehicle 306a for overtaking the vehicle 306c may be generated. This may ensure safety of driver while performing driving actions such as overtaking. In additions, having prior knowledge of traffic data associated with the lane segment 304b and adjacent lane segments, i.e., the lane segments 304a and 304c may enable driver of the vehicles 306 to perform driving actions such as lane changing and overtaking with greater safety and reliability.

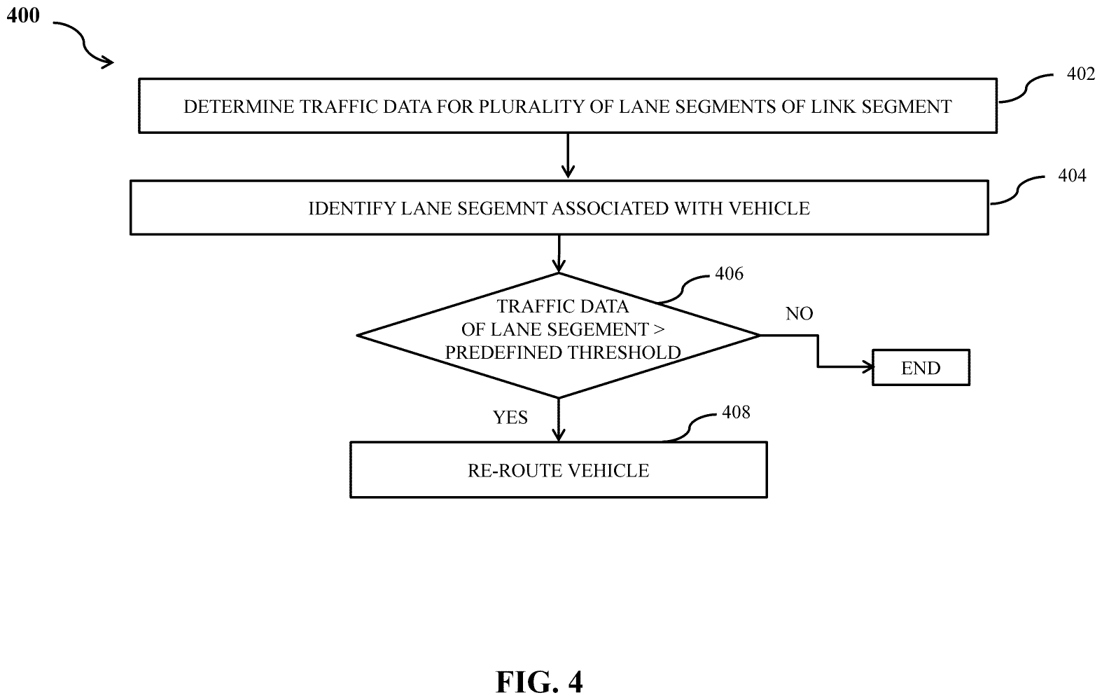

FIG. 4 illustrates a method 400 for regulating traffic on lane segments based on corresponding traffic data, in accordance with an example embodiment. In particular, the processor 202 may be configured to generate navigation instructions for navigating along the link segment 302 based on traffic data associated with the lane segments 304.

At 402, traffic data associated with a plurality of lane segments of a link segment may be determined. In an example, the processor 202 is configured to determine traffic data or traffic congestion value for the lane segments 304 associated with the link segment 302, based on corresponding lane distance data. Further, the processor 202 may be configured to regulate traffic on the lane segments 304, based on the corresponding traffic data.

At 404, a lane segment associated with a vehicle may be identified. The vehicle may be an incoming vehicle (not shown) or an existing vehicle, say 306a. For example, the incoming vehicle may have to enter the link segment 302, whereas the existing vehicle may be already travelling on the link segment 302, for example, in a lane segment having high traffic congestion value, say the lane segment 304b. In an example, the lane segment on which the incoming vehicle may enter the link segment 302 or the existing vehicle 306a is travelling may be determined as the lane segment 304b. Further, traffic data associated with the lane segment 304b may be retrieved.

At 406, a determination may be made to check if the traffic data or traffic congestion value of the lane segment 304b is greater than or equal to a predefined threshold or not.

At 408, on determining the traffic congestion value for the lane segment 304b to be greater than the predefined threshold, i.e., high congestion or traffic, the incoming vehicle, or the existing vehicle 306a may be re-routed. In this regard, the processor 202 may be configured to re-route the incoming vehicle or the existing vehicle 306a to avoid travelling on the lane segment 304b or from entering the link segment 302 using the lane segment 304b. In such a case, navigation instructions indicating travelling on lane segments, such as 304a or 304c having traffic congestion value less than the predefined threshold may be provided to the incoming vehicle or the existing vehicle 306a.

It may be noted that, at 406, on determining traffic congestion value for the lane segment 304b on which the incoming vehicle may enter or the existing vehicle 306a is already travelling to be less than the predefined threshold, the method 400 may end.

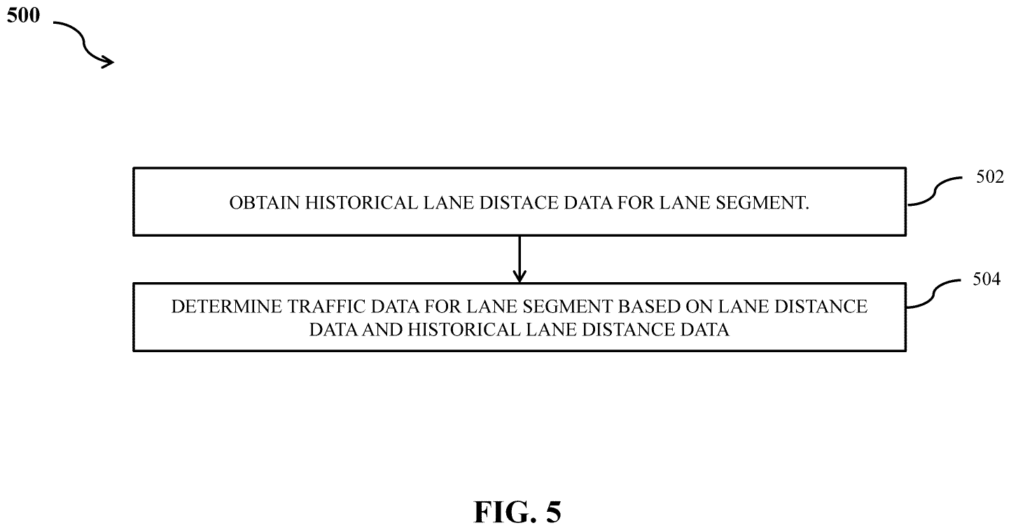

Referring to FIG. 5, there is shown an example method 500 for determining traffic data, in accordance with an example embodiment. In particular, traffic data for the lane segments 304 may be generated based on historical data.

In this regard, at 502, historical lane distance data for a lane segment may be obtained. In an example, historical lane distance data may be obtained for the lane segment 304b. The historical lane distance data may include historical forward average distance data, or historical backward average distance data. The historical forward average distance data or the historical backward average distance data may be pre-computed data, for example, based on historical sensor data (historical forward distance data and historical backward distance data) obtained during a historical time periods similar to a first time period. In particular, the traffic data is to be calculated in real-time for the first time period, say 4:00 PM on Friday; and the historical time period may correspond to 4:00 PM on Thursday, or 4:00 PM on Friday of a previous week. For example, the historical forward average distance data and the historical backward average distance data may be similar to the forward average distance data and the backward average distance data determined by the processor 202.

At 504, the traffic data for the lane segment 304 during the first time period may be determined based on the lane distance data and the historical lane distance data. In an example, the average distance threshold may be determined based on the historical lane distance. Further, the traffic data during the first time period may be determined based on a comparison between the present lane distance data and the average distance threshold. In another example, present or real-time lane distance data may be unavailable or skewed. In such a case, the traffic data during the first time period may be determined based on a comparison between the historical lane distance data and the average distance threshold.

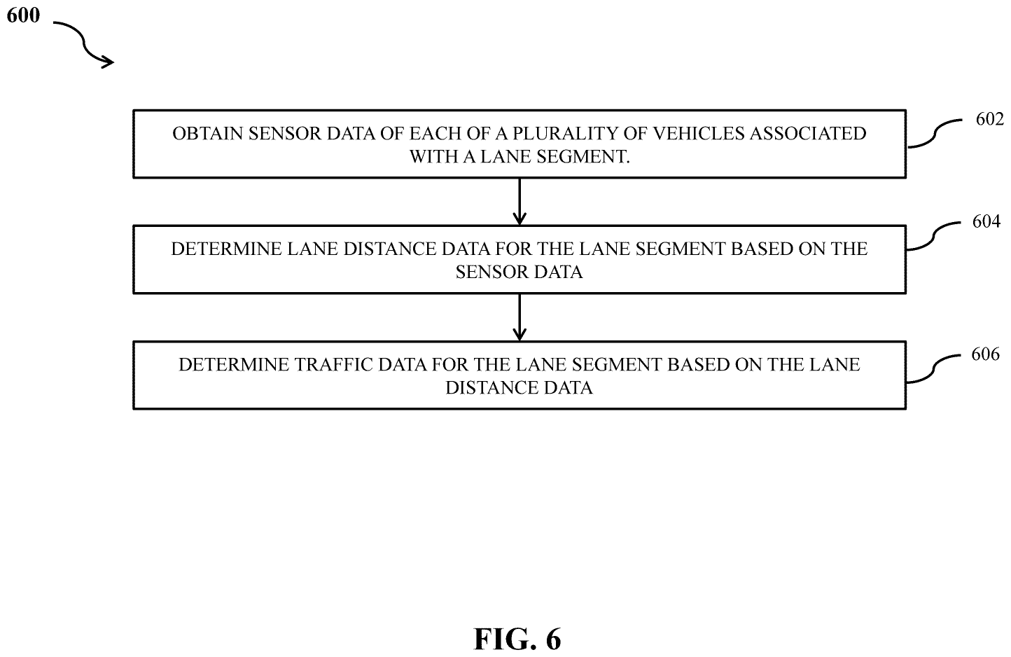

FIG. 6 illustrates a method 600 for determining traffic data of the lane segment 304b according to an embodiment. The steps of the method 600 may be implemented by the system 102 and/or the processor 202. Fewer, more, or different steps may be provided.

At 602, sensor data of each of the vehicles 306 associated with the lane segment 304b may be obtained. For example, the sensor data includes forward distance data of one or more vehicles in vicinity of each of the vehicles 306 in the lane segment 304b, or backward distance data of the one or more vehicles in the vicinity of each of the vehicles 306 in the lane segment 304b. In an example, forward distance data from the vehicle 306a may indicate a distance between the vehicle 306a and corresponding forward vehicle 306c in vicinity of the vehicle 306a on the lane segment 304b. In addition, backward distance data from the vehicle 306a may indicate a distance between the vehicle 306a and corresponding backward vehicle 306b in vicinity of the vehicle 306a on the lane segment 304b.

At 604, lane distance data for the lane segment 304b may be determined. The lane distance data may be determined based on the sensor data. The lane distance data may include forward average distance data and/or backward average distance data. In an example, the forward average distance data may be determined based on the forward distance data associated with corresponding forward vehicles for each of the vehicles 306. Moreover, the backward average distance data may be determined based on the backward distance data associated with corresponding backward vehicles for each of the vehicles 306.

At 606, traffic data for the lane segment 304b may be determined based on the lane distance data. In an example, the traffic data comprises a traffic congestion value for the lane segment 304b, a vehicle density value for the lane segment, or a combination thereof. For example, the traffic congestion value for the lane segment 304b may be determined based on a comparison of an average distance threshold and the lane distance data. For example, if the lane distance data is greater than the average distance threshold, a high traffic congestion value may be determined for the lane segment 304b. Such high traffic congestion value may be greater than a predefined threshold. Alternately, if the lane distance data is less than the average distance threshold, a low traffic congestion value may be determined for the lane segment 304b. Such low traffic congestion value may be less than the predefined threshold.

In an example, the traffic data or the traffic congestion value for the lane segment 304b may be used to determine a color for displaying the lane segment on a map based display interface. In another example, on determining the traffic congestion value to be greater than the predefined threshold, updated navigation instructions for a vehicle, say the vehicle 306a, travelling in the lane segment 304b may be generated to re-route the vehicle 306a. In yet another example, navigation instructions may be generated for regulating traffic on the lane segments 304, based on the corresponding traffic data. In certain cases, navigation instructions comprising instructions for driving actions, such as lane changing and/or overtaking may also be generated based on the traffic data to ensure reliable and precise routing of the vehicle 306.

Accordingly, blocks of the flowcharts 400, 500 and 600 support combinations of means for performing the specified functions and combinations of operations for performing the specified functions. It will also be understood that one or more blocks of the flowcharts 400, 500 and 600, and combinations of blocks in the flowcharts 400, 500 and 600, can be implemented by special purpose hardware-based computer systems which perform the specified functions, or combinations of special purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the methods 400, 500 and 600 disclosed herein, the end result generated by the system 102 is a tangible lane-level traffic data for a lane segment for enabling navigation and routing operations. The lane-level traffic data is crucial to provide precise and real-time lane-level traffic condition information to users to ensure better navigation planning, generating lane-level navigation instructions and reduced frequent lane changing operations, thereby ensuring driver safety.

Returning to FIG. 1, the system 102 may be embodied as a cloud based service, a cloud based application, a cloud based platform, a remote server based service, a remote server based application, a remote server based platform, or a virtual computing system. In yet another example embodiment, the system 102 may be an OEM (Original Equipment Manufacturer) cloud. The OEM cloud may be configured to anonymize any data received by the system 102, such as from the image based sensors for the vehicles 106, before using the data for further processing, such as before sending the data to map database 104b. In an example, anonymization of the data may be done by the mapping platform 104.

The network 108 may be wired, wireless, or any combination of wired and wireless communication networks, such as cellular, Wi-Fi, internet, local area networks, or the like. In some embodiments, the network 108 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The mapping platform 104 may comprise suitable logic, circuitry, and interfaces that may be configured to store one or more map attributes and sensor data associated with traffic on link segments and lane segments. The mapping platform 104 may be configured to store and update map data indicating the traffic data along with other map attributes, road attributes and traffic entities, in the map database 104b. The mapping platform 104 may include techniques related to, but not limited to, geocoding, routing (multimodal, intermodal, and unimodal), clustering algorithms, machine learning in location based solutions, natural language processing algorithms, and artificial intelligence algorithms. Data for different modules of the mapping platform 104 may be collected using a plurality of technologies including, but not limited to drones, sensors, connected cars, cameras, probes, and chipsets. In some embodiments, the mapping platform 104 may be embodied as a chip or chip set. In other words, the mapping platform 104 may comprise one or more physical packages (such as, chips) that includes materials, components and/or wires on a structural assembly (such as, a baseboard).

In some example embodiments, the mapping platform 104 may include the processing server 104a for conducting the processing functions associated with the mapping platform 104 and the map database 104b for storing map data. In an embodiment, the processing server 104a may comprise one or more processors configured to process requests received from the system 102. The processors may fetch sensor data and/or map data from the map database 104b and transmit the same to the system 102 in a format suitable for use by the system 102.

Continuing further, the map database 104b may comprise suitable logic, circuitry, and interfaces that may be configured to store sensor data and map data, which may be collected from the image based sensors and/or the vehicles 106 traveling on a lane segment, or in a region close to the lane segment. In accordance with an embodiment, such sensor data may be updated in real time or near real time such as within a few seconds, a few minutes, or on hourly basis, to provide accurate and up to date sensor data. The sensor data may be collected from any sensor that may inform the mapping platform 104 or the map database 104b of features within an environment that are appropriate for traffic related services. In accordance with an embodiment, the sensor data may be collected from any sensor that may inform the mapping platform 104 or the map database 104b of features within an environment that are appropriate for mapping. For example, motion sensors, inertia sensors, image capture sensors, proximity sensors, LIDAR (light detection and ranging) sensors, and ultrasonic sensors may be used to collect the sensor data. The gathering of large quantities of crowd-sourced data may facilitate the accurate modeling and mapping of an environment, whether it is a road link or a link within a structure, such as in an interior of a multi-level parking structure.

The map database 104b may further be configured to store the traffic-related data and road topology and geometry-related data for a road network as map data. The map data may also include cartographic data, routing data, and maneuvering data. The map data may also include, but not limited to, locations of intersections, diversions to be caused due to accidents, congestions, or constructions, suggested roads or links to avoid, and ETAs depending on different links. In accordance with an embodiment, the map database 104b may be configured to receive the map data including the road topology and geometry-related attributes related to the road network from external systems, such as, one or more of background batch data services, streaming data services and third party service providers, via the network 110.

In accordance with an embodiment, the map data stored in the map database 104b may further include data about changes in traffic situation registered by GPS provider(s), such as, but not limited to, incidents, road repairs, heavy rains, snow, fog, time of day, day of week, holiday or other events which may have influence on the traffic condition of a lane segment or a link segment.

In some embodiments, the map database 104b may further store historical probe data for events (such as, but not limited to, traffic incidents, construction activities, scheduled events, and unscheduled events) associated with Point of Interest (POI) data records or other records of the map database 104b.

For example, the data stored in the map database 104b may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot or other types of navigation. While example embodiments described herein generally relate to vehicular travel, example embodiments may be implemented for bicycle travel along bike paths, boat travel along maritime navigational routes, etc. The compilation to produce the end user databases may be performed by a party or entity separate from the map developer. For example, a customer of the map developer, such as a navigation device developer or other end user device developer, may perform compilation on the received map database 104b in a delivery format to produce one or more compiled navigation databases.

Returning to FIG. 2, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to conduct various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notification associated with the navigation instructions, such as traffic data, traffic conditions, traffic congestion value, ETA, routing information, road conditions, driving instructions, etc., on the user equipment or audio or display onboard the vehicles 106 via the I/O interface 206.

In some embodiments, the processor 202 may be configured to provide Internet-of-Things (IoT) related capabilities to users of the system 102 disclosed herein. The IoT related capabilities may in turn be used to provide smart city solutions by providing real time warnings, big data analysis, and sensor-based data collection by using the cloud based mapping system for providing accurate navigation instructions and ensuring driver safety. The I/O interface 206 may provide an interface for accessing various features and data stored in the system 102.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system comprising:
a memory configured to store computer executable instructions; and
one or more processors configured to execute the instructions to:
obtain sensor data of each of a plurality of vehicles associated with a lane segment, the sensor data comprising at least one of: forward distance data of one or more vehicles in vicinity of each of the plurality of vehicles in the lane segment, and backward distance data of the one or more vehicles in the vicinity of each of the plurality of vehicles in the lane segment;
determine lane distance data for the lane segment based on the sensor data, wherein the lane distance data comprises forward average distance data, and backward average distance data; and
determine traffic data for the lane segment based on the lane distance data.

2. The system of claim 1, wherein to obtain the sensor data of the plurality vehicles associated with the lane segment, the one or more processors are further configured to:
obtain, based on map data, lane location data relating to the lane segment;
determine, based on the obtained sensor data, vehicle location data for each of the plurality of vehicles;
generate map matched data for each of the plurality of vehicles based on the lane location data and the corresponding vehicle location data, the map matched data indicating a matching between the vehicle location data and the lane location data; and
determine the plurality of vehicles of the map matched data as the vehicles corresponding to the lane segment.

3. The system of claim 1, wherein the one or more processors are further configured to:
determine an average distance threshold for the lane segment, based on map data;
determine a traffic congestion value for the lane segment based on a comparison of the average distance threshold and the lane distance data; and
update a map database based on the comparison.

4. The system of claim 3, wherein the one or more processors are further configured to:
determine a color for displaying the lane segment on a map based display interface, based on the traffic congestion value; and
cause to display the lane segment in association with the determined color during a time period.

5. The system of claim 3, wherein the one or more processors are further configured to:
on determining the traffic congestion value to be greater or equal to than a predefined threshold, generate updated navigation instructions for a vehicle travelling in the lane segment to re-route the vehicle.

6. The system of claim 1, wherein the traffic data comprises at least one of: a traffic congestion value for the lane segment, a vehicle density value for the lane segment, or a combination thereof.

7. The system of claim 1, wherein the one or more processors are further configured to:
determine an average error value associated with at least one of: the forward distance data of each of the plurality of vehicles in the lane segment, and the backward distance data of each of the plurality of vehicles in the lane segment; and
update the lane distance data for the lane segment based on the average error value.

8. The system of claim 7, wherein the one or more processors are further configured to:
combine the forward average distance data and the backward average distance data based on corresponding average error value; and
determine the lane distance data for the lane segment based on the combination.

9. The system of claim 1, wherein the one or more processors are further configured to:
obtain historical lane distance data for the lane segment, the historical lane distance data comprising at least one of: historical forward average distance data and historical backward average distance data; and
determine the traffic data for the lane segment during a first time period based on the lane distance data and the historical lane distance data.

10. The system of claim 1, wherein the one or more processors are further configured to:
determine traffic data for one or more lane segments associated with a link segment, based on corresponding lane distance data; and
generate navigation instructions for regulating traffic on the one or more lane segments, based on the corresponding traffic data.

11. The system of claim 1, wherein the one or more processors are further configured to:
determine forward vehicle distance data for a vehicle from the plurality of vehicles based on the sensor data, the forward vehicle distance data comprising at least a first distance between the vehicle and a first forward vehicle, and a second distance between the first forward vehicle and a second forward vehicle; and
on determining the first distance to be less than a first threshold and the second distance to be greater than or equal to a second threshold, generate navigation instructions for the vehicle for overtaking the first forward vehicle.

12. A method comprising:
obtaining sensor data of each of a plurality of vehicles associated with a lane segment, the sensor data comprising at least one of: forward distance data of one or more vehicles in vicinity of each of the plurality of vehicles in the lane segment and backward distance data of the one or more vehicles in vicinity of each of the plurality of vehicles in the lane segment;
determining lane distance data for the lane of the link segment based on the sensor data, wherein the lane distance data comprises forward average distance data and backward average distance data; and
determining traffic data for the lane segment based on the lane distance data.

13. The method of claim 12, wherein to obtain the sensor data of the plurality vehicles associated with the lane segment, the method further comprises:
obtaining, based on map data, lane location data relating to the lane segment;
determine, based on the obtained sensor data, vehicle location data for each of the plurality of vehicles;
generating map matched data for each of the plurality of vehicles based on the lane location data and the vehicle location data, the map matched data indicating a matching between the vehicle location data and the lane location data; and
determining the plurality of vehicles of the map matched data as the vehicles corresponding to the lane segment.

14. The method of claim 13, the method further comprising:
determining an average distance threshold for the lane segment, based on map data;
determining a traffic congestion value for the lane segment based on a comparison of the average distance threshold and the lane distance data; and
updating a map database based on the comparison.

15. The method of claim 14, the method further comprising:
determining a color for displaying the lane segment on a map based display interface, based on the traffic congestion value; and
causing to display the lane segment in association with the determined color during a time period.

16. The method of claim 14, the method further comprising:
on determining the traffic congestion value to be greater than or equal to a predefined threshold, generating updated navigation instructions for a vehicle travelling in the lane segment to re-route the vehicle.

17. The method of claim 12, the method further comprising:
obtaining historical lane distance data for the lane segment, the historical lane distance data comprising at least one of: historical forward average distance data and historical backward average distance data; and
determining the traffic data for the lane segment during a first time period based on the lane distance data and the historical lane distance data.

18. The method of claim 12, the method further comprising:
determining forward vehicle distance data for a vehicle from the plurality of vehicles based on the sensor data, the forward vehicle distance data comprising at least a first distance between the vehicle and a first forward vehicle, and a second distance between the first forward vehicle and a second forward vehicle; and
on determining the first distance to be less than a first threshold and the second distance to be greater than or equal to a second threshold, generating navigation instructions for the vehicle for overtaking the first forward vehicle.

19. A computer programmable product comprising a non-transitory computer readable medium having stored thereon computer executable instructions, which when executed by one or more processors, cause the one or more processors to conduct operations comprising:
obtaining sensor data of each of a plurality of vehicles associated with a lane segment, the sensor data comprising at least one of: forward distance data of one or more vehicles in vicinity of each of the plurality of vehicles in the lane segment and backward distance data of the one or more vehicles in vicinity of each of the plurality of vehicles in the lane segment;
determining lane distance data for the lane of the link segment based on the sensor data, wherein the lane distance data comprises forward average distance data and backward average distance data; and
determining traffic data for the lane segment based on the lane distance data.

20. The computer programmable product of claim 19, the method further comprising:
obtaining, based on map data, lane location data relating to the lane segment;
determine, based on the obtained sensor data, vehicle location data for each of the plurality of vehicles;
generating map matched data for each of the plurality of vehicles based on the lane location data and the vehicle location data, the map matched data indicating a matching between the vehicle location data and the lane location data; and
determining the plurality of vehicles of the map matched data as the vehicles corresponding to the lane segment.
